(19) United States
(12) Patent Application Publication
(10) Pub. No.: US 2009/0058052 A1
(43) Pub. Date: Mar. 5, 2009

(54) Knee Air Bag Module and Method of Assembly

(75) Inventors: Brian C. Ford, Mt. Clemens, MI (US); Thomas G. Busacca, Shelby Township, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: KEY SAFETY SYSTEMS, INC., Sterling Heights, MI (US)

(21) Appl. No.: 12/198,167

(22) Filed: Aug. 26, 2008

Related U.S. Application Data
(60) Provisional application No. 60/968,227, filed on Aug. 27, 2007.

(51) Int. Cl. B60R 21/231

(52) U.S. Cl. 280/730.1

(57) ABSTRACT

An air bag module including a housing (90) having an open mouth or top, an inflator (50), a knee air bag (60, 60a) received with the housing and inflatable by the inflator, the knee air bag configured to move out of the housing (90) along a first direction and to inflate laterally across the top of the housing along a second direction and upon full inflation to move generally opposite to the first direction to protect the legs of an occupant of a vehicle.

### BACKGROUND AND SUMMARY OF THE INVENTION

This application claims the benefit of U.S. Provisional Application 60/968,227, filed on Aug. 27, 2007. The disclosure of the above application is incorporated herein by reference.

The present invention relates to a knee air bag module for an automotive vehicle and method of assembling the module.

Reference is briefly made to FIG. 1, which illustrates a typical mounting location for a knee air bag and knee air bag module 40. Knee air bag modules are most often located within the lower regions of the instrument panel 20 of a vehicle typically below the steering wheel 21. One purpose of a knee air bag is to generate a blocking force on the lower leg of the occupant to prevent the occupant from submarining below the instrument panel and generally moving forward during an accident. The occupant is designated by numeral 22.

It is an object of the present invention to provide an improved knee air bag module and method of assembly. The invention comprises an air bag module comprising: a housing (90) having an open mouth or top, an inflator (50), a knee air bag (60, 60a) received with the housing and inflatable by the inflator, the knee air bag configured to move out of the housing (90) along a first direction and to inflate laterally across the top of the housing along a second direction and upon full inflation to move generally opposite to the first direction to protect legs of an occupant of a vehicle.

Many other objects and purposes of the invention will be clear from the following detailed description of the drawings.

### BRIEF DESCRIPTION OF THE DRAWINGS

FIG. 1 shows the mounting orientation and location of a prior art knee air bag.

FIG. 2 shows the major components of the knee air bag module according to the present invention.

FIG. 2a is a cross-sectional view of an inflator usable with the present invention.

FIGS. 2b and 2c are views of a front and rear panel of a complete air bag according to the present invention.

FIGS. 2d and 2e show views of a housing of the module.

FIG. 3 is a view of the underside of a cover.

FIG. 3a is a view of the top side of the cover.

FIG. 4 illustrates an assembly step in which the inflator is inserted within a housing; the air bag is diagrammatically shown for purpose of illustration.

FIG. 4a illustrates another assembly step in which the narrow end of the initiator is inserted within an opening in the housing.

FIG. 4b is substantially the same as FIG. 4a and shows a press washer of FIG. 4a holding the terminal end of the inflator to the housing.

FIG. 4c an assembled module including the cover secured to the housing.

FIG. 4d is a cross-sectional view of a complete module illustrating a folded air bag about an inflator and within a housing.

FIG. 5 shows the major components of a knee air bag of the present invention.

FIG. 5a shows the main panel of the air bag with reinforcement panels secured thereto.

FIG. 5b shows a partially constructed air bag.

FIG. 5c shows the air bag in FIG. 5b after another process step.

FIG. 5d shows the air bag after an additional process step.

FIGS. 5e and 5f show sectional views of the complete air bag.

FIGS. 5g and 5h show an alternate embodiment of a knee air bag.

FIG. 6 shows the above air bag inflated and located between the instrument panel of the vehicle and the legs of the occupant.

FIGS. 7a-7c show another embodiment of a knee bag according to the present invention.

FIG. 8 shows an alternate construction of an inflator and housing according to the present invention.

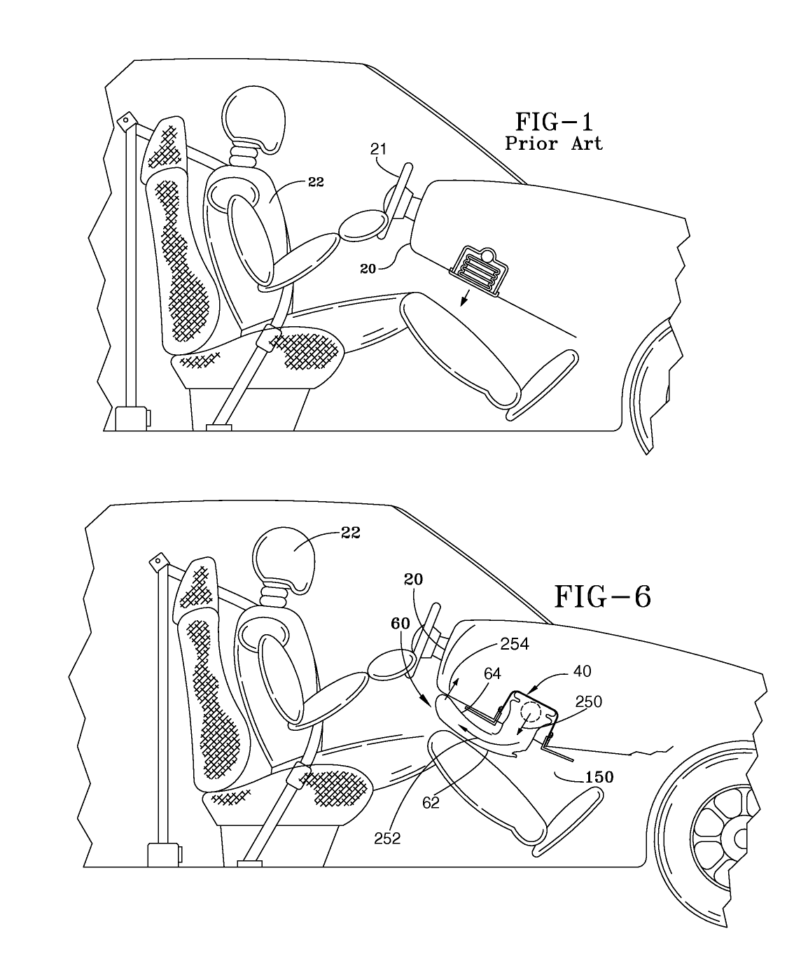

### DETAILED DESCRIPTION OF THE DRAWINGS

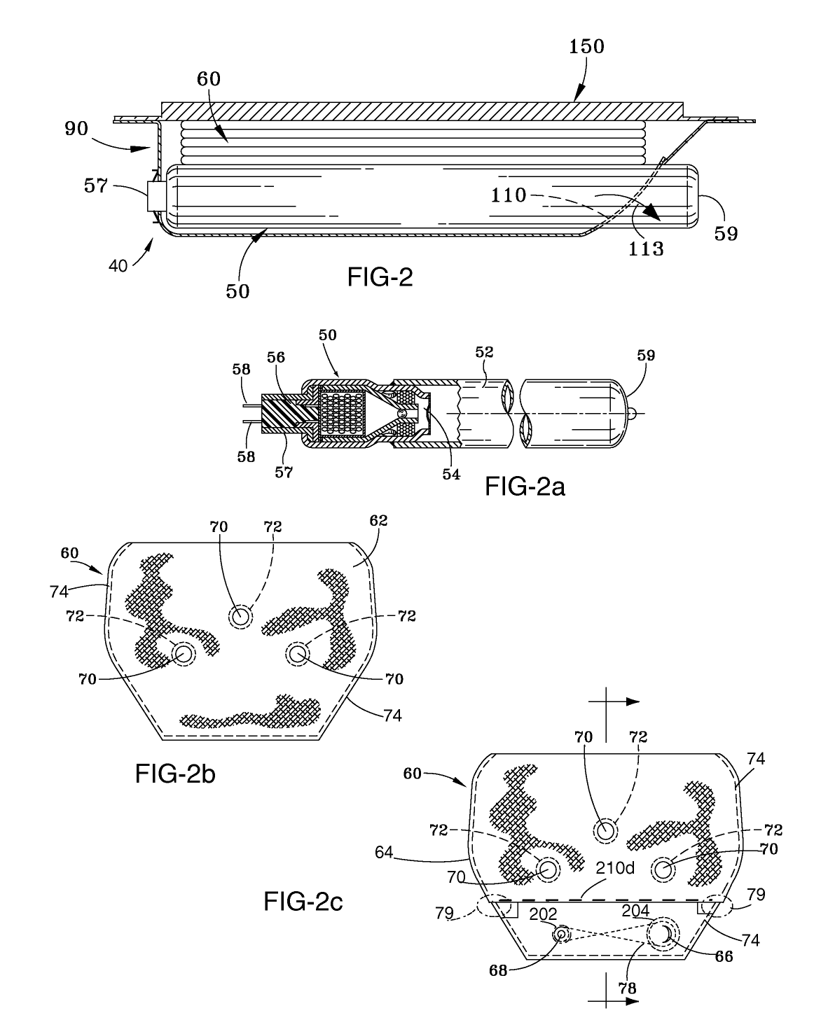

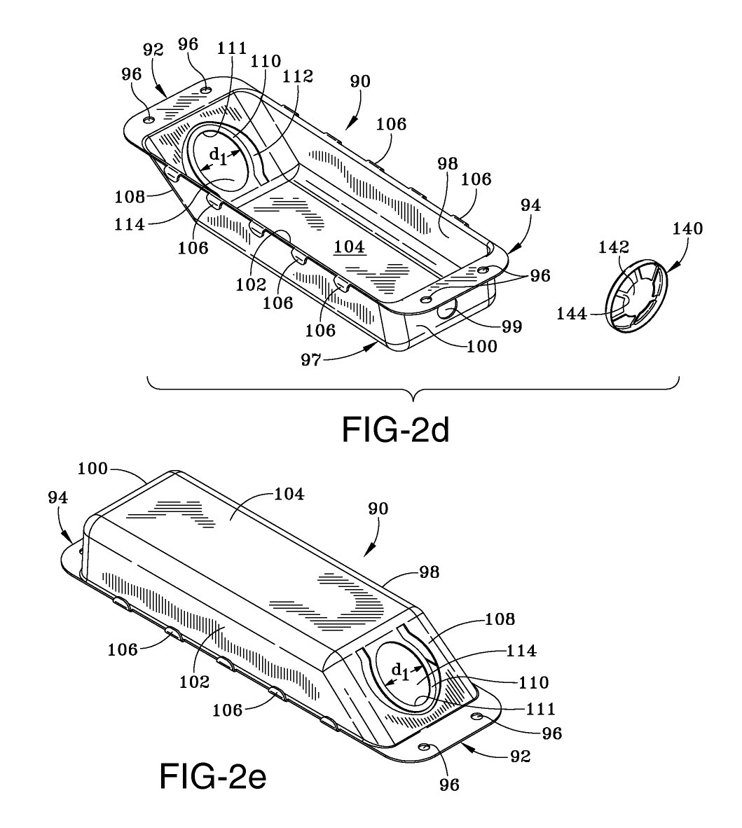

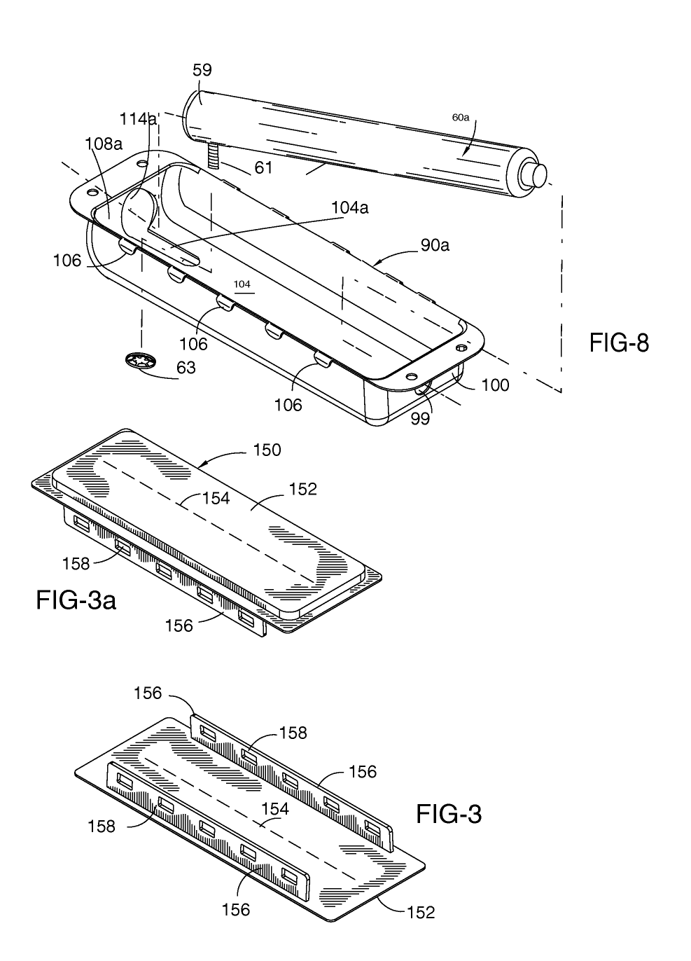

FIG. 2 shows a side view of a completed air bag module 40 according to the present invention. The major components of module 40 include inflator 50, knee air bag 60, housing 90 and cover 150, which are shown in FIGS. 2a-2e as well as in FIG. 3a. The module 40 also uses press washer 140 which is shown over-sized in FIG. 2d. Many different air bag inflators can be used with the present invention; the illustrated inflator 50 is a stored cold gas inflator, however, a pyrotechnic, hybrid or other type of inflator can also be used. Inflation gas is stored in the body 52 of inflator 50 and is often one of: nitrogen, helium, argon or even atmospheric air. Inflator 50 additionally includes a burst disc 54 that is opened by operation of an igniter 56 of known construction. Activation signals are communicated to the inflator through electric terminals 58, which are within terminal end 57 of the inflator; the inflator also includes an opposite end 59 (that is, opposite the terminal end).

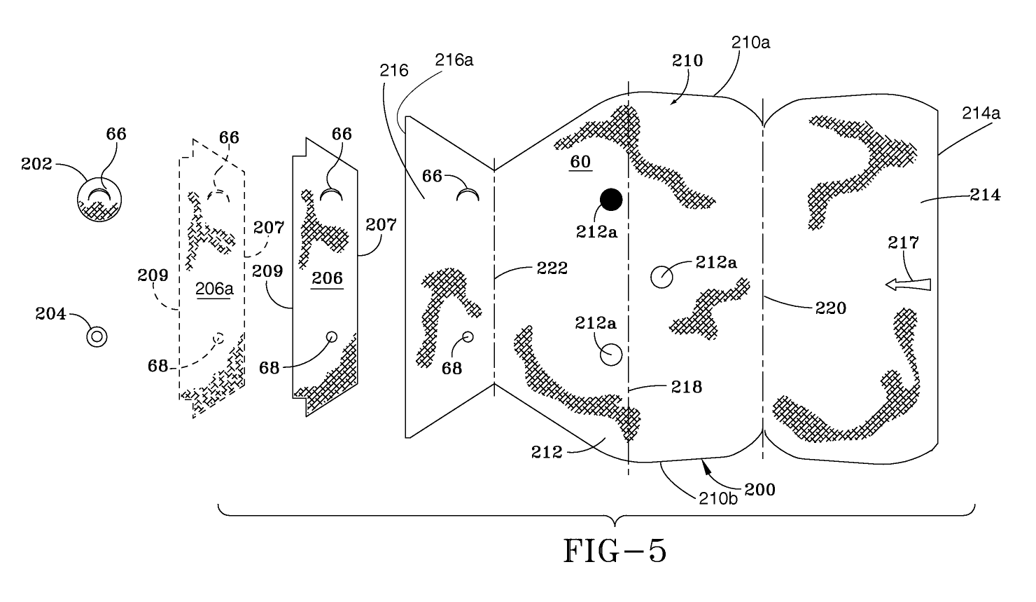

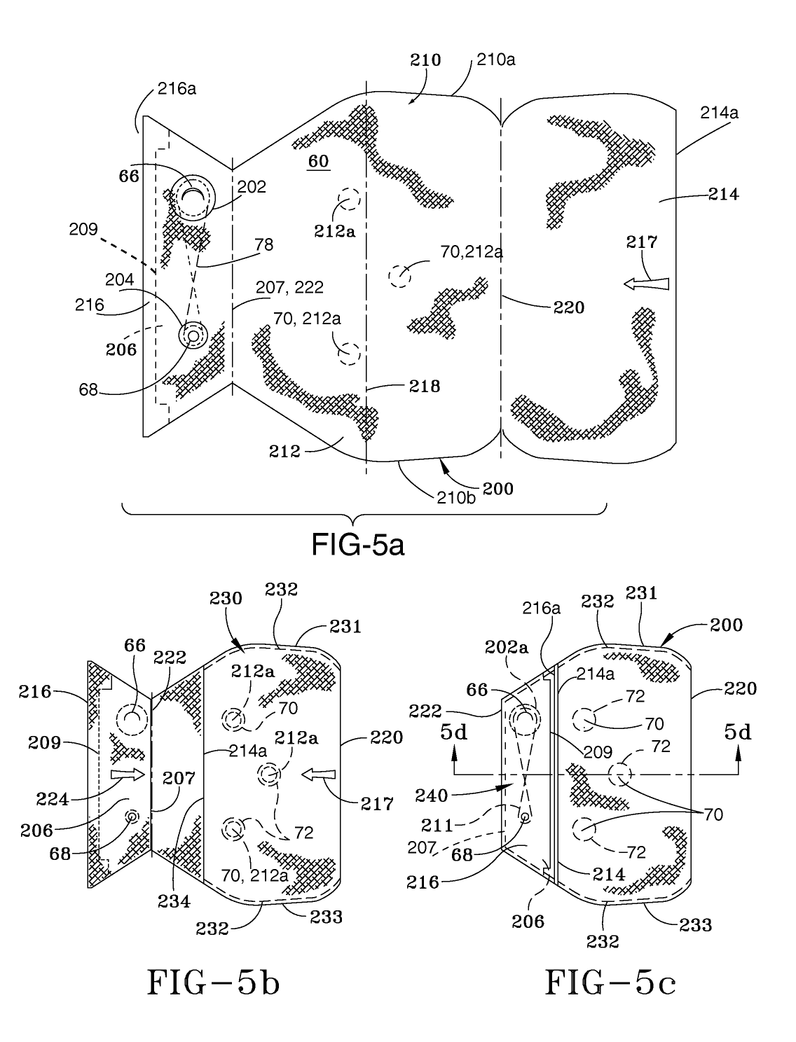

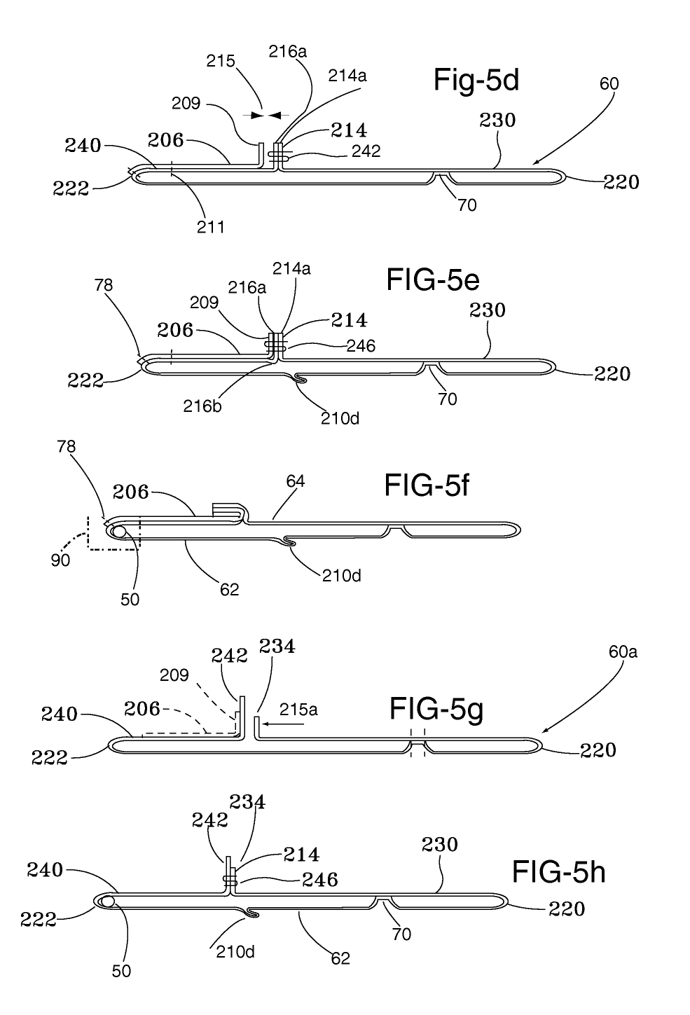

FIG. 2b shows a front panel or portion 62 of the air bag 60, while FIG. 2c shows the rear panel or portion 64 of the air bag. Air bag 60 in the illustrated embodiment has a main panel 200 divided into a center portion 210 and two side portions 214 and 216 as shown in FIG. 5. When the air bag is constructed, the center portion 210 of the main panel forms the front panel 62 and the two side portions 214 and 216 upon being sewn to the center portion form the rear panel 64. On inflation of the air bag, the front panel 62 (or center portion 210) bears against the legs of the occupant while the rear panel (side portions 214, 216) bears against the lower portions of the instrument panel. The rear panel includes an arcuate slot or slit 66 as well as an opening 68. The terminal end 57 is first inserted into the slit 66. The body 52 is also pushed through slit 66. Thereafter terminal end 57 is manipulated so it extends out of opening 68. With terminal end 57 in the above position the other end 59 will extend from slit 66. Air bag 60, as described below, may include one or more reinforcement panels 202 and 204 that can be located below the openings 66 and 68 to reinforce the region of the air bag about these openings; the reinforcement panels are shown in FIG. 5. A first seam 78 in the shape of a figure-8 is placed about the openings 66 and 68 securing the reinforcement panels 202 and 204 to the main panel of the air bag. Air bag 60 includes a number of other regions such as 70 in which the front panel and the rear panel of the air bag are joined together at a plurality of joints or seams 72. The joints or seams 72 can be formed by heat welding or by sewing. These seams prevent the air bag from taking on a more spherical shape upon inflation and give the air bag 60 a relatively narrow profile as it inflates. In FIGS. 2 and 2a the joints or seams are shown as circular but they can take any shape required to control the shape of the inflated air bag.

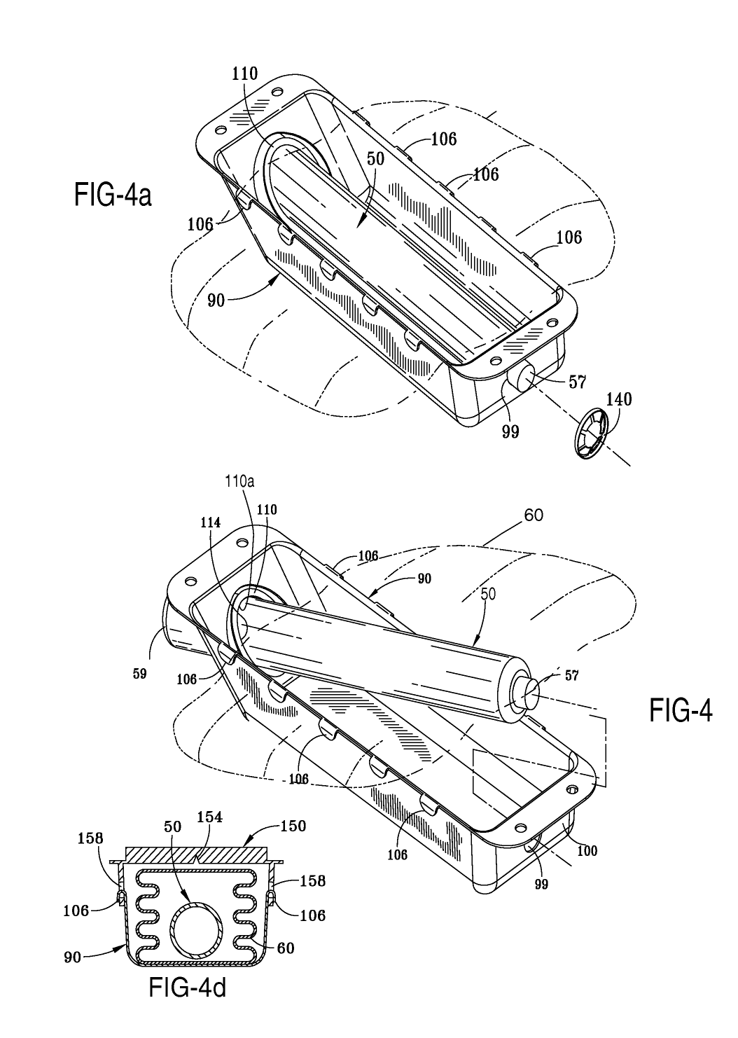

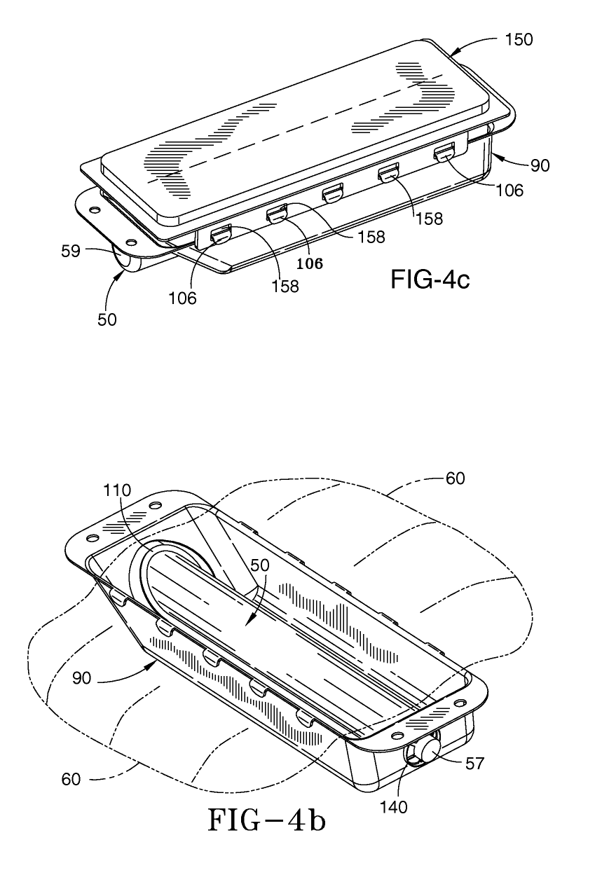

Housing 90, shown in FIGS. 2d and 2e, is typically made from a metal stamping but can be cast metal or plastic. An alternate housing 90a and inflator 60a are shown in FIG. 8. Housing 90 includes two extending mounting flanges 92 and 94, each having a plurality of mounting openings 96. The housing is formed in the shape of a cup or trough 97 having four sides; three of the sides are numbered 98, 100 and 102. Each of these sides is generally perpendicular to a bottom 104. Sides 98 and 100 include a plurality of outwardly extending tabs 106, which secure cover 150 to the housing as further shown in FIG. 4c. The housing additionally includes side 108, which extends outwardly on an angle between the bottom 104 and one of the mounting flanges 92. Side 108 includes a breakout or cut-away section generally shown by 110; the breakout section 110 is defined by a thin bendable and resilient loop or partial loop of metal 111 separated from adjacent portions of the housing 90 by a thin space of removed or cut-away material 112. The breakout section 110 has an oval opening 114, the minor diameter d1 of which is substantially equal to the diameter of the inflator and of sufficient size to receive the body of the inflator and to provide a press-fit with the sides of the inflator body, enabling the inflator body to be inserted into the opening 114 and held by the sides of the breakout section 110. As mentioned above the module 40 also includes a press washer 140 typically manufactured as a metal stamping with a central opening 142 and a plurality of radial slots 144 and is received about and secures the terminal end of the inflator from moving relative to the housing 90. If the terminal end of the inflator were threaded, a threaded washer could replace the press washer.

Reference is briefly made to FIGS. 3, 3a and 4c, which illustrate various views of cover 150. Cover 150 is manufactured of molded plastic and includes a top 152 and a tearable seem 154, which may be visible or invisible when viewed from the top side of the cover. The cover 150 is urged outwardly by the inflating air bag and will separate into two halves. The cover 150 includes two depending flanges 156 extending from the underside of the top 152. Each flange includes a set of rectangular openings 158. FIG. 4c shows the cover secured to housing 90 and more particularly illustrates the tabs 106 extending through the openings 158.

Reference is briefly made to FIGS. 4-4d. FIG. 4 illustrates the combination of inflator 50 and air bag 60 being assembled to the housing 90. As mentioned above, after inflator 50 is inserted into the air bag, both ends 57 and 59 of the inflator extend from respective openings 66 and 68 of the air bag. For the purpose of illustration however in FIGS. 4, 4a and 4b the air bag is diagrammatically illustrated. In FIG. 4, end 59, which extends from air bag 60, has been inserted into opening 114, and in this illustrated assembly step, end 59 of the inflator (and air bag) is elevated relative to housing 90. As shown in FIG. 4a, inflator 50 (and the air bag to which it is attached) has been rotated downward from the position shown in FIG. 4, to a horizontal orientation in the housing 90; the air bag is not yet folded. Subsequently end 57 of the inflator is aligned with opening 99 in side 100 of the housing and slid rearward to and through opening 99, permitting the terminal end 57 of inflator 50 to extend out of opening 99. Thereafter the press washer 140 is secured about the terminal end 57 to achieve the configuration illustrated in FIG. 4b. The air bag 60 is diagrammatically illustrated in FIG. 4b with portions of air bag 60 extending from and about the inflator and these portions of the air bag are also positioned in and about the housing. Subsequently, the air bag is folded or rolled into a compact configuration as diametrically illustrated in FIG. 4d and cover 150 is secured to the housing, completing the construction of the module as shown in FIGS. 4c and 4d. As can be appreciated, a cover for the air bag can be secured to the lower portions of the instrument panel instead of being fastened to the housing.

As mentioned above, as well as shown in FIG. 4, the inflator, after it is inserted in the air bag, is initially inserted within opening 114 of the breakout portion 110 and then subsequently rotated downwardly to enable the terminal end 57 to be inserted in opening 99. As the inflator is rotating downwardly, the inflator 50 will engage the top portion 110a of the breakout member 110 and bend the breakout member 110 as the inflator is moved from the position as illustrated in FIG. 4a. The breakout member 110, which is part of the metal housing 90, acts as a leaf spring applying a bias force or force couple (see arrow 113) to the body of the inflator. With the inflator positioned through opening 99 in the housing, the breakout member 110 continues to apply bias force, securing the inflator in its place in the housing. The breakout or deformable member 111, as illustrated in FIG. 2 and in FIG. 4b, securely holds inflator 50 to the housing 90 by virtue of the restoring force 113 (shown in FIG. 2) generated by the deformable member on the inflator body and by virtue of the press-fit attachment achieved between the inflator body and the deformable member 111.

Reference is briefly made to FIG. 8 which shows an alternate housing 90a and inflator 50a. Inflator 50a differs from inflator 50 with the addition of a stud 61 that has been attached to the inflator body by welding or other means. The stud 61 as illustrated is metal and threaded but can be smooth. In housing 90a, side 108a extends from bottom 104 in a generally perpendicular manner similar to side 100. Side 108a includes an opening 114a of dimension to permit inflator end 59 to be slid therethrough. Bottom 104 includes an open groove 104a that intersects opening 114a. After inflator 50a is inserted into the air bag 60, the air bag and inflator are manipulated so end 59, as well as stud 61, extends from opening 66. The inflator end 59 is inserted into opening 114a. As the inflator 50a is moved into the housing 90a the stud 61 enters into groove 104a. In this manner, the inflator can be pushed through opening 114a permitting end 57 to clear side 100. Thereafter, end 57 is aligned with opening 99 and the inflator 50a is slid toward side 100 permitting end 57 to extend through opening 99. As the inflator is so moved, the stud 61 is repositioned within groove 104a. The inflator 50a is secured to the housing 90a by a threaded nut or threaded washer 63 which is attached to stud 61. If the stud has smooth walls a press washer can be substituted for the nut 63. If needed the press washer 140, mentioned above, can be placed about end 57 to further secure the inflator 50a to the housing. The air bag 60 is folded about the inflator 50a in the manner described above.

Reference is made to FIG. 5, which illustrates the major components of air bag 60. Air bag 60 includes a main panel 200 and reinforcement panels that reinforce the main panel 200 in the vicinity of the split 66 and opening. Panel 202 is used to reinforce the inflator receiving split 66 and reinforcement panels 204 is used to reinforce the area of the air bag about opening 68. If added reinforcement is needed two or more of each reinforcement panel 202 and 204 can be stacked on each other. Panel or panels 202 include another slit 66 while panel or panels 204 include another opening 68. The air bag may additionally include additional panels such as 206 and 206a. For the purpose of illustration these panels are the same size and shape. Panel 206a is shown in phantom line to indicate this may be an optional panel for the embodiment of FIG. 5. These panels 206, 206a can be used as additional reinforcement to supplement panels 202 and 204 or one or both panels 206 or 206a can be used to replace panels 202 and 204. If used, panel 206a can be placed within the air bag 60 and additionally functions as a heat shield. Panel 206 can be placed on an outside surface of the air bag and acts as a tether which controls the position of portions of the rear panel. Each reinforcement panel 206 and 206a includes slit 66 and opening 68. It is not necessary for any slit 66 or opening 68 to be pre-formed in a reinforcement panel, each slit 66 and opening 68 can be formed through these panels by cutting, laser forming or by using other similar techniques after or during assembly.

Main panel 200 includes a center portion or center panel portion 210 and side portions or side panel portions 214 and 216 formed on respective side of fold lines 220 and 222. The center portion includes lateral sides 210a and 210b. Side portions include a respective end 214a and 216a. The centerline of main panel 200 is shown by numeral 218. For the purpose of illustration the various reinforcement panels are shown adjacent to end 216a of the side panel portion 216 of the main panel 200 in FIG. 5. Fold lines 220 and 222 are also superimposed on the main panel 200. Additionally, as a manufacturing aid a plurality of circles 212a are drawn, printed or stamped upon the main panel 200. Since the main panel 200 is made of a woven material, the manufacturing aids will most probably be visible even if placed on what will become an interior surface of the main panel 200. The manufacturing aids identify the locations 70 where the panel can be joined together, see FIG. 2b, as well as the location of a plurality of seams 72. The manufacturing aids such as the circles 212a can be filled in or shown by a line which highlights the outline of the circle as shown (both versions are shown in FIG. 5).

In FIG. 5a the main panel of the air bag is positioned so that its interior surface is visible. Reinforcement panel 206, which forms a tether, has been positioned upon an outside surface of the main panel 200 with an edge 207 close to or coincident with a fold line 222. The opposing edge 209 of panel 206 is spaced from a corresponding edge 216a of the main panel. Additionally, in FIGS. 5a and 5b reinforcement panel 206, panel 206a if used, and the other reinforcement panels such as 202 and 204 have been secured to the main panel by the figure-8 pattern sew-seam 78. Sew-seam 78 also has circular portions 213 surrounding slit(s) 66 and opening(s) 68. In this embodiment the circular seamed portion 213 holds the reinforcement panel(s) to the inside of the main panel. The reinforcement panels 202 and 204 are also shown in FIG. 5a. In the preferred embodiment of this air bag, the reinforcement panel such as 204 is not needed and the curved slit 66 and opening 68 are formed after reinforcement panels are secured to the inside surface of the main panel 202 and are laser-cut.

During another step of the assembly of air bag 60, panel portion 214 is moved in the direction of arrow 217 to the left as viewed in FIG. 5 and folded over a fold line 220 yielding the configuration shown in FIG. 5b. The folded-over panel portion 214 is secured to the main panel 200 in three areas 70 by three circular seams 78 at the location of the above-mentioned manufacturing aids. By securing panel 214 to the main panel 200 at three locations the two panels will lie on each other rather flatly, at least between the areas 70 and the edge or peripheral seam 74. The edge seams 74 will aid in keeping these panels flat (the edge seams are also shown in FIGS. 2b and 2c). The manufacturing aids are not shown in FIG. 5b. At this point in the assembly process the exposed edge 214a of the side panel portion 214 of the main panel 200 is unsecured. Also, the edges 231 and 233 of the center panel portion 210 and side panel portion 214 are not yet secured. Side panel portion 216 including the reinforcement panels 202, 204, 206 and/or 206a, which were previously attached to panel portion 216, is moved in the direction of arrow 224 and folded over fold line 222 to achieve the configuration shown in FIG. 5c. In this configuration, side panel portions 214 and 216, as well as ends 214a and 216a, lie generally opposite one another. Similarly, at this stage of assembly end edge 216a of the side panel 216 is unsecured, additionally side panel portion 216 is also not yet sewn to the center portion 210.

Reference is briefly made FIG. 5d, which is a cross-sectional view through section line 5d-5d of FIG. 2 in which panel ends 214a and 216a are secured together via a joint or seam 246. Edge 209 of reinforcement/tether panel 206 is yet unsecured and is shown in a raised position spaced away from the joined-together ends 214a and 216a for the purpose of illustration.

The edges 214a and 216a of the side panels 214 and 216 are moved relatively together placing the ends 214a and 216a adjacent one another; these ends are sewn together by seam 242. The sewn-together ends of the side panel portions 214 and 216, as well as end 209 of tether panel 206, are moved relative to each other, and end 209 of the tether 206 is sewn to the two ends 214 and 216 by seam 246. As the spacing between the tether end 209 and the joined-together tether ends 214a and 216a narrows, see arrows 215, some portions of side panel 216 will lie loosely or pleat or pucker under tether panel 216; this loose portion (pleat, pucker) is shown by numeral 216b. This loose material will extend across the width of the air bag generally along the mated ends 214a, 216a and 207; the outside end of this loose material is also shown in the completed air bag of FIG. 2a by numeral 79. To facilitate assembly, seams 242 and 246 may be replaced by a single seam 246 which connects each of the three ends together in one operation.

The above relative movement of the panel portions and tether panel also creates some slack (another pleat, pucker) in the center portion 210 of the main panel; this slack is shown by numeral 210d which is also shown in FIG. 2c. The sewn-together ends 209, 214a and 216a are folded down along the periphery of the air bag and side panel portions 214 and 216 are sewn to the center panel portion 210 of the peripheral seam 74. FIG. 5f diagrammatically shows the ends 207, 214a and 216a bent down and laid on the tether panel; also inflator 50 is shown in air bag 60.

As previously mentioned the inflator is inserted first through the slot 66 and manipulated so the terminal end 57 exits opening 68. Thereafter this subcombination of the inflator 50 and completed air bag 60 is placed into the housing 90 and the inflator manipulated in a manner as described above. FIG. 5f includes housing 90 superimposed upon the air bag to show the relative position of the parts of the main panel prior to folding the air bag. Upon inflation the center portion 210 (also referred to as front panel 62 in FIGS. 2 and 2a) will be pressed against the legs of the occupant as shown in FIG. 6. The side portions 214 and 216 of the main panel (comprises the previously mentioned rear panel 64 in FIGS. 2 and 2a) will be facing and pushes against the instrument panel (also shown in FIG. 6).

Reference is briefly made to FIG. 6, which illustrates the present invention mounted to the vehicle's instrument panel with the air bag inflated. As inflation gas exits the inflator and begins to fill the air bag, the air bag begins to inflate in a first direction 250 (essentially perpendicular to the bottom of the housing 90) causing the cover 150 to burst along the burst or tear lines, permitting one-half of the top to rotate upward and a lower portion of the top to rotate downward as the air bag moves our of the housing. As the air bag moves out of the housing because of the placement of the inflator 50 in the air bag, the air bag will begin to inflate and expand along a second direction 252, generally perpendicular to the first direction 250. As the air bag continues to inflate, the rear facing panel 64 (comprising panel portions 214 and 216) proximate the instrument panel will become stressed prior to the time the front or occupant facing panel 62 (center portion 210 of the folded main panel) becomes stressed because of the extra fabric that forms the pleat or pucker 210d. In the illustrated embodiment, the pleat 210d is located between the location of inflator 50 and the connected regions 70 in the center portion 210 of the air bag. With the rear facing panel of the air bag stressed and as the air bag continues to fill, the additional inflation gas entering into the air bag causes the air bag to be urged in a third direction 254 generally opposite the initial movement 250 of the air bag. In the illustrated embodiment this third direction gives the air bag a component of motion upwardly and away from the occupant's legs and helps the air bag to remain adjacent to the instrument panel rather than assume a trajectory that is more outward and more forcefully directed at the legs of the occupant to be protected.

Reference is briefly made to FIGS. 5g and 5h which show another embodiment of a knee air bag 60a and shows two steps in the fabrication of an alternate embodiment of the air bag 60a. Air bag 60a is substantially the same as air bag 60 with the major exception of the removal of the reinforcement/tether panel 206 located on an exterior surface of panel portion 216. If needed air bag 60a may include reinforcement panel 206a on an interior surface, generally opposite where panel 206 was mounted on an exterior surface. In FIG. 5e (the prior embodiment) the ends 214a and 216a, of panel portions 214 and 216, were moved together, sewn and then the pulled relatively toward end 209. This movement created the excess material, pleat or pucker 216b under an end of panel 216 and also created the generally opposite pleat or pucker 210d in the center portion 210. Obviously, in this embodiment, the tether panel 206 is not used, however, a pleat or pucker 210d that is similar to pleat or pucker 210d can be created in the center portion 210 of air bag 60a using the following steps. With reference to FIG. 5g, the end of panel 216 has been pulled and lifted upward simulating the movement of the panel 216 toward to the position of the tether panel 206 for the construction of air bag 60. Even though not used in FIG. 5g, the tether panel 206 is shown for the purpose of illustration in phantom line. Thereafter, end 214a of panel portion 214 is moved to the lifted panel portion 216, this movement suggested by arrow 215a. Upon the relative movement of and closure of the spacing between of the panel ends 214a and 216a, the pleat or pucker 210d is created on the right-hand side of center portion 210 (also previously referred to as the front panel). Upon inflation, this air bag 60a will display the same tendency as displayed by air bag 60 to inflate as the rear panel tensions prior to the front panel having the pleat 210d. Inflator 50 is also shown in FIG. 5h.

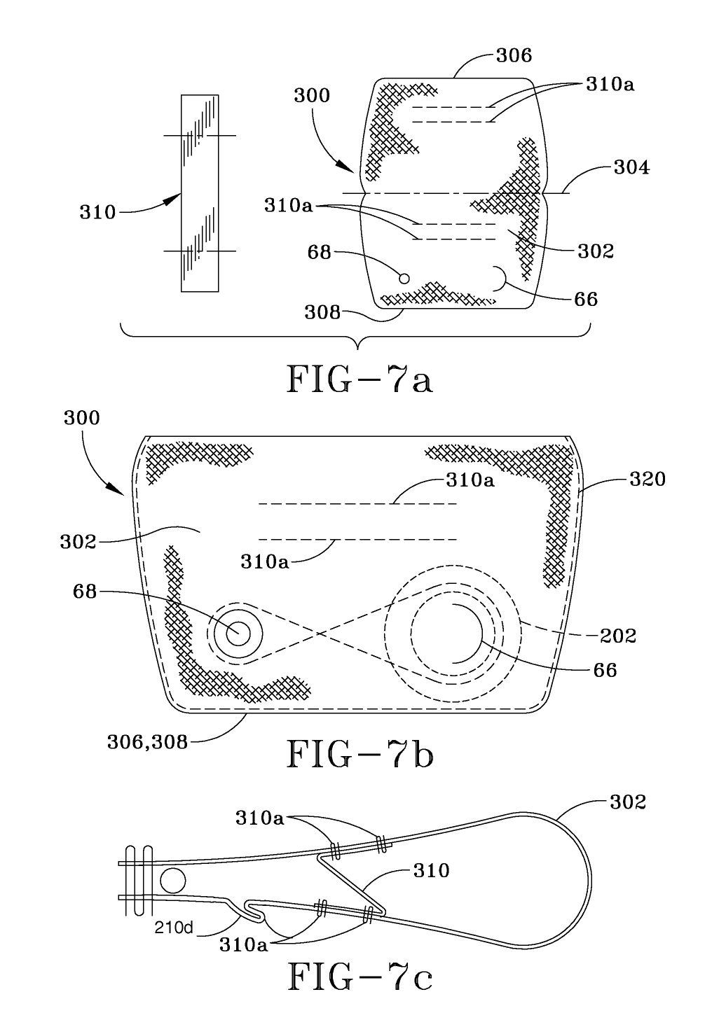

Reference is now made to the FIGS. 7a-7e, which illustrate an alternate construction of an air bag 300. FIG. 7a shows a main panel 302 with a centerline 304 symmetrically located within the main panel 302. Air bag 300 additionally includes a tether panel designated by 310; this tether panel is generally rectangular in shape. FIG. 7a also shows the location of sewn seams 310a, which generally show where the tether panel 310 is connected to the front and rear panel portions of the main panel 302 in a “Z” configuration as illustrated in FIG. 7c. This internally tethered construction is a substitute for sewing the front and rear panel directly together at locations 70 shown above. With the tether panel secured at the main panel at the designated locations of the seams 310a, end 306 is folded over the centerline 304 and aligned with end 308 to yield the configuration in FIGS. 7b and 7c. The main panel 302 also includes the arcuate slot 66 and small opening 68 for receipt of inflator 50. The folded-over portion of the main panel 302 is sewn to the remaining portion of the main panel along a U shaped sew seam 320. The Z constructed tether 310 is sometimes in the art referred to as a three-dimensional tether. The inflator 50 is inserted into bag 300 in the same manner as with bag 60 and the air bag 300 and inflator 50 are similarly mated with the housing. The tether panel 310 can have a configuration of main panel 200 shown in FIG. 5 above. The occupant facing portion or panel of air bag 60a also includes a pleat 210d.

Many changes and modifications in the above-described embodiment of the invention can, of course, be carried out without departing from the scope thereof. Accordingly, that scope is intended to be limited only by the scope of the appended claims.

1. An air bag module comprising:
a housing (90) having an open mouth or top, an inflator (50), a knee air bag (60, 60a) received within the housing and inflatable by the inflator,
the knee air bag configured to move out of the housing (90) along a first direction and to inflate laterally across the top of the housing along a second direction and upon full inflation to move generally opposite to the first direction to protect the legs of an occupant of a vehicle.

2. The air bag module according to claim 1 wherein the knee air bag includes a front panel (62) and a rear panel (64), and an opening to receive the inflator (50), the front and rear panels are configured that upon inflation of the air bag, there is a delay between when the rear panel becomes tensioned generally along the second direction and when the front panel becomes tensioned along the second direction, the rear panel becoming tensioned first, thereby causing the air bag to move generally opposite the first direction as the air bag fully inflates.

3. The air bag module according to claim 2 wherein the front and rear panels are joined together in one connection zone (78, 310) at a distance from the location of the inflator.

4. The air bag module according to claim 3 wherein the front and rear panels are connected directly together at a plurality of zones (73).

5. The air bag module according to claim 4 wherein the front and rear panels are connected together by a tether (310).

6. The air bag module according to claim 3 wherein the front panel includes, in a region between the location of the inflator and the at least one connection zone, a portion of material that can be pleated or folded, such pleated or folded material configured to contribute to the delay.

7. The module according to claim 6 wherein the knee air bag (60, 60a) comprising a main panel (200) having a center portion (210) and two side portions (214 and 216), the side portions configured to be folded over the center portion of main panel, the center portion forming the front panel and the two side portions forming the rear panel.

8. The air bag module according to claim 7 wherein the two folded-over side portions of the main panel are secured to the center portion at one or more edge joints or seams, the air bag including a reinforcement panel that is secured to one of the folded-over sections and configured to be relatively movable relative to the two folded-over sections of the main panel or at least portions of the two folded-over sections and configured once moved to create a pleat or pucker in one of the folded-over portions of the main panel effectively creating excess material in one of the folded-over sections permitting that folded-over section to inflate belatedly relative to the other folded-over section.

9. The air bag module according to claim 2 wherein the housing (90) includes an integrally formed resilient ring (110) which receives a portion of the inflator (50), the resilient ring configured to be bent upon rotation of the inflator, the resilient ring configured to create a holding force to secure the inflator to the housing.

10. The air bag module according to claim 9 wherein the housing includes sets of opposing tabs (106) and wherein the module further includes a cover, the cover including a like set of depending flanges (156) each flange including a number of openings (158), each opening (158) configured to receive one tab.
